(19) United States
(12) Patent Application Publication
(10) Pub. No.: US 2009/0316887 A1
(43) Pub. Date: Dec. 24, 2009

(54) DATABASE ENCRYPTION AND QUERY METHOD KEEPING ORDER WITHIN BUCKET PARTIALLY

(76) Inventors: Donghyuk LEE, Daejeon (KR); Seungmin LEE, Daejeon (KR); Taek Yong NAM, Daejeon (KR); Yong-Sung JEON, Daejeon (KR); Sang-Woo LEE, Daejeon (KR); Jong Soo JANG, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/136,809

(22) Filed: Jun. 11, 2008

(30) Foreign Application Priority Data
Dec. 18, 2007 (KR) 10-2007-0133673

(51) Int. Cl. H04L 9/00

(52) U.S. Cl. 380/44; 380/277; 707/3; 707/E17.014

(57) ABSTRACT

A database encryption and query method keeping an order within a bucket partially, which encrypts and stores numeric data in a database, includes calculating a relative value of a plaintext within a bucket to which the plaintext is allocated; generating a first key value by producing a random number within the bucket; generating a second key value for defining a function having a bucket range of the bucket as an input; and changing the relative value based on the first and the second key value with keeping an order of the relative value partially to store the changed relative value. The first key value may be a value of separating order informations on the relative value. Further, the second key value may be a resultant value obtained by applying a mod 2 operation to the bucket size of the bucket.

### CROSS-REFERENCE(S) TO RELATED APPLICATIONS

The present invention claims priority of Korean Patent Application No. 10-2007-0133673, filed on Dec. 18, 2007, which is incorporated herein by reference.

### FIELD OF THE INVENTION

The present invention relates to a database encryption and query method; and, more particularly, a database encryption and query method suitable for safely encrypting and storing numeric data in a database and effectively querying the numeric data from the database.

This work was supported by the IT R&D program of MIC/IITA. [2007-S-021-01, Development of Integrated Security Technology for Personal Information Database]

### BACKGROUND OF THE INVENTION

When a personal information such as social security numbers, account numbers or the like is stored in a database, symmetric cryptosystems such as a data encryption standard (DES) and an advanced encryption standard (AES), public key cryptosystems or asymmetric cryptosystems are conventionally applied to protect the personal information. Since the symmetric cryptosystems have an operation speed faster than the public key cryptosystems or the asymmetric cryptosystems, the symmetric cryptosystems are generally used in a database that makes much of query performance. In the following description, a comparison will be made based on the symmetric cryptosystems.

However, when querying data encrypted and stored in a database using such a conventional method, query performance may be lowered. The reason is that an order of ciphertexts stored in one of columns included in a specific table of a database is different from that of plaintexts prior to encryption, and thus, query speed optimization cannot be implemented with indexing provided from a database management system (DBMS). That is, since an order of plaintexts of data included in a column is different from that of ciphertexts, data constituting indices of the plaintexts are different from those constituting indices of the ciphertexts. Particularly, in a range query, when a query text is requested by a user, a query is performed sequentially after all the encrypted data are decrypted. Therefore, the speed at which data stored using the symmetric cryptosystems are queried may be considerably lowered as compared with the speed at which plaintexts are stored and queried as they are.

A bucket-based indexing method is used as a conventional art suggested to solve the aforementioned problem.

In the method, as shown in FIG. 4, encryption is performed with respect to entire rows constituting an original table using the conventional indexing method, and bucketing is then performed with respect to data of a column to be used as an index.

As shown in FIG. 4, the left and the right table are an original plaintext table and an encryption table to which the bucket-based indexing method is applied, respectively.

Column “Etuple” in the right table has a structure in which original five columns are encrypted being concatenated through the known cryptosystems (AES, DES, etc.), and encryption is performed for each column using the bucket-based indexing method.

In case of column “Salary” in the left table, “λ” is allocated to a value between 10 and 20, and “ρ” is allocated to a value between 10 and 20. When a value in the range of 15 to 25 is queried in the column “Salary”, 15 and 25 correspond to “λ” and “ρ”, respectively. Thus, all values corresponding “λ” and “ρ” are fetched, and values in the column “Etuple” are encrypted, so that all plaintexts corresponding to “λ” and “ρ” in the column “Salary” can be seen.

At this time, the same bucket number is allocated to all data within a bucket range, and the bucket number is used as index information. Thus, in order to obtain a plaintext value exactly matched through a match query, there is required an additional filtering process of fetching a bucket containing a queried value, decrypting all the values in the bucket, and then comparing the decrypted values. When a range query is applied, there is also required a filtering process of fetching all buckets containing corresponding values and decrypting all encrypted values in the buckets.

Therefore, since an exact value is obtained after encrypted values having the same bucket ID are all decrypted, it is not considered practical that the conventional art supports the match and range queries. In addition, since information on other values except a value satisfying a query expression should be decrypted, there may be caused a safety problem in that additional information is exposed.

As described above, when data are encrypted, stored in a database, or queried from a database, a query performance problem or a safety problem of cryptosystems themselves may be caused.

### SUMMARY OF THE INVENTION

It is, therefore, an object of the present invention to provide a method capable of storing with being encrypted safely and effectively querying by keeping an order within a bucket partially with respect to numeric data constituting a column of a table in a database.

Another object of the present invention is to provide a method capable of effectively encrypting and querying numeric data in a database by keeping an order within a bucket partially so that a speed problem can be solved in match, range, MIN, MAX and COUNT queries, and a safety problem can be solved by applying conventional symmetric cryptosystems in a changing process.

In accordance with the present invention, there is provided a database encryption and query method keeping an order within a bucket partially, which encrypts and stores numeric data in a database, including: calculating a relative value of a plaintext within a bucket to which the plaintext is allocated; generating a first key value by producing a random number within the bucket; generating a second key value for defining a function having a bucket range of the bucket as an input; and changing the relative value of the plaintext based on the first and the second key value with keeping an order of the relative value partially to store the changed relative value.

The first key value may be a value of separating order informations on the relative value of the plaintext with the random number produced within the bucket range as a border.

The second key value may be a resultant value obtained by applying a mod 2 operation to the bucket size of the bucket.

When the resultant value is 1, it is preferable that the relative value is changed by arranging values within the bucket range in a forward order.

Further, when the resultant value is 0, it is preferable that the relative value is changed by arranging values within the bucket range in a reverse order.

The method may further include decrypting for obtaining the relative value of the plaintext based on the first and the second key value with the changed relative value as an input value.

In accordance with the present invention, when storing important data in a database and querying the stored data from the database, with the present invention being applied to a database system, safety for the stored data can be secured, and query results can be effectively provided in match, range, MIN, MAX and COUNT queries. Not only integers but also real numbers to changed into integers can be used as the numeric data. In addition, numeric type character data such as social security numbers and account numbers can be changed into numbers and applied to the present invention.

### BRIEF DESCRIPTION OF THE DRAWINGS

The above and other objects and features of the present invention will become apparent from the following description of embodiments given in conjunction with the accompanying drawings, in which:

FIG. 1 is a block diagram schematically showing a configuration of a database processing system for implementing a method in accordance with the present invention;

FIG. 2 is a flowchart illustrating a database processing method keeping an order within a bucket partially in accordance with an embodiment of the present invention;

FIGS. 3A and 3B are exemplary views illustrating the database processing method of FIG. 2; and

FIG. 4 is an exemplary view illustrating a conventional bucket-based indexing method.

### DETAILED DESCRIPTION OF THE EMBODIMENTS

Hereinafter, embodiments of the present invention will be described in detail with reference to the accompanying drawings so that they can be readily implemented by those skilled in the art.

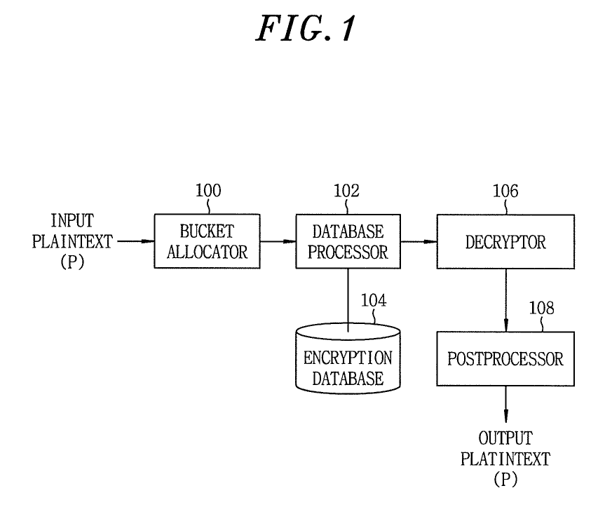

FIG. 1 is a block diagram schematically showing the configuration of a system for implementing a database processing method for keeping an order within a bucket partially in accordance with an embodiment of the present invention. The system includes a bucket allocator 100, a database processor 102, an encryption database 104, a decryptor 106 and a postprocessor 108.

As shown in FIG. 1, the bucket allocator 100 serves to allocate an inputted plaintext, e.g., a numeric data m (an integer or real number), to a specific bucket and to provide the allocated plaintext to the database processor 102.

The database processor 102 in accordance with the present invention serves to calculate a relative value based on a bucket range of the bucket allocated from the bucket allocator 100 and to change the calculated relative value with keeping an order within the bucket partially.

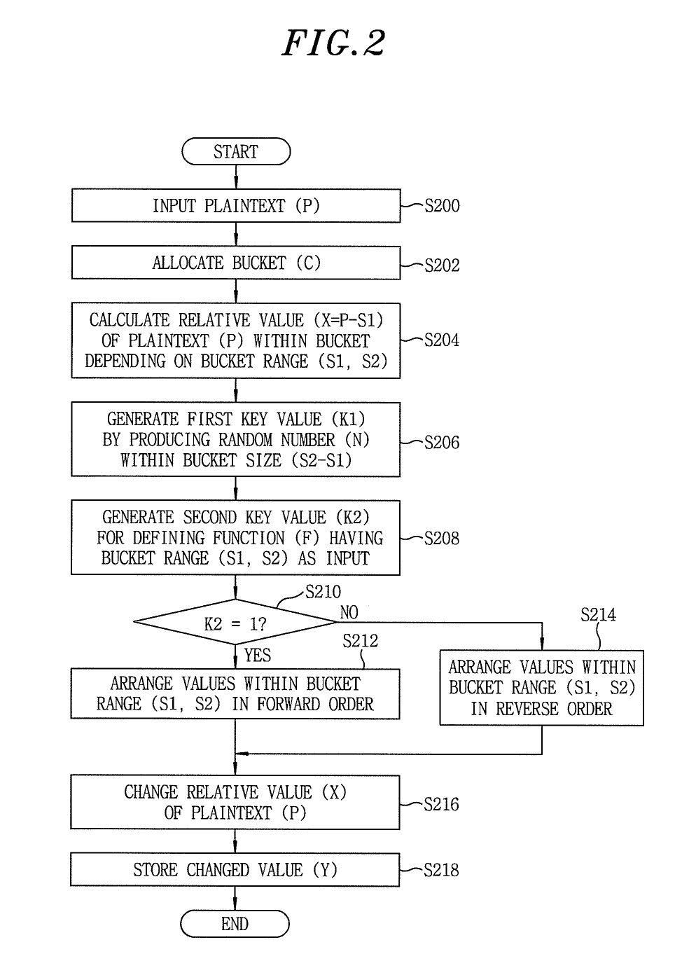

More specifically, the database processor 102 serves to generate a first key value by producing a random number within the bucket size of the allocated bucket, to generate a second key value for defining a function having the bucket range of the allocated bucket as an input, and to change the relative value by arranging values within the bucket range in a forward or reverse order depending on the generation result of the second key value. Such a database processing through keeping an order within a bucket partially will be described in detail with reference to the following flowchart of FIG. 2.

The relative value is changed by the database processor 102 to be stored in the encryption database 104, and the changed relative value stored in the encryption database 104 may be provided to the decryptor 106 through an encryption data query later.

The decryptor 106 functions the decryption into a plaintext by using the changed relative value provided by the database processor 102, and the postprocessor 108 functions to operate and output the plaintext decrypted by the decryptor 106.

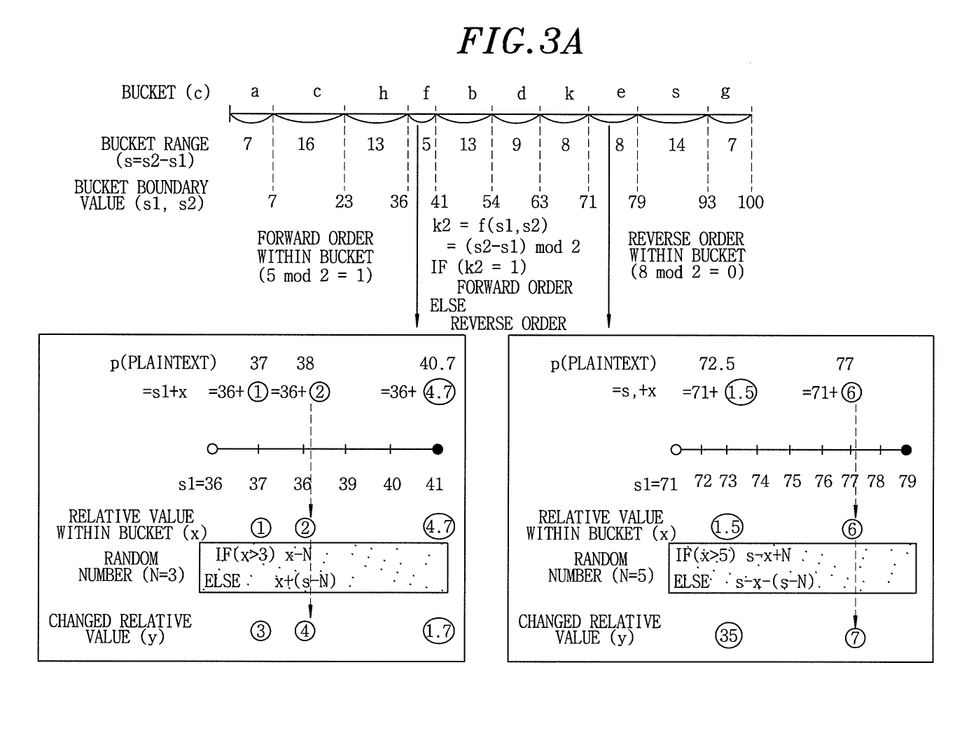

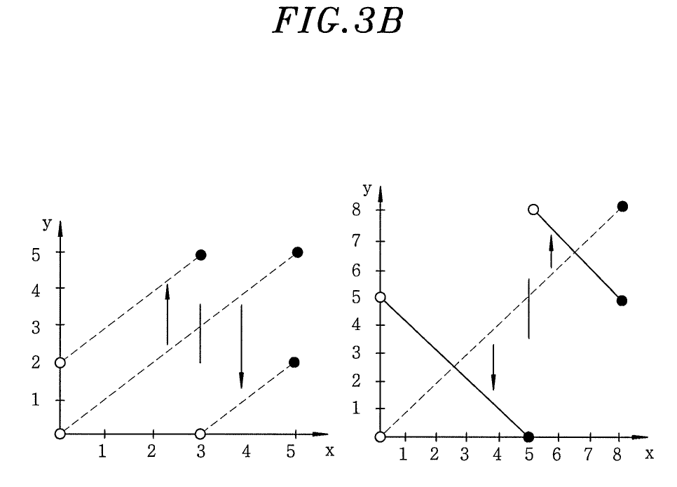

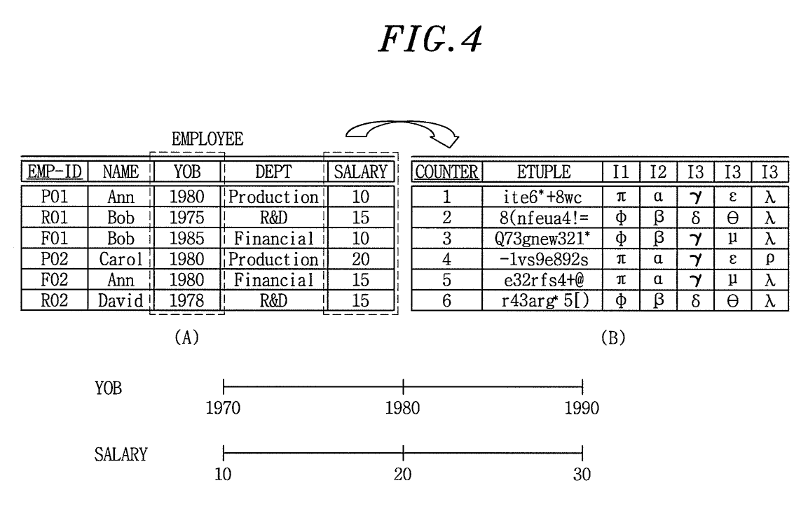

Hereinafter, a database processing method for keeping an order within a bucket partially in accordance an embodiment of the present invention will be described in detail together with the aforementioned configuration with reference to FIGS. 2 and 3.

In conventional bucketing, only bucket information (bucket ID) is used in allocating a plaintext to a specific bucket. That is, when various plaintexts are allocated to the same bucket, the bucket informations of them are the same as each other. Since, in case where a match or a range query is requested, an exact value within a bucket is not queried, an additional filtering process should be performed after encrypted values included in the bucket are all decrypted. Therefore, in the conventional art using only bucket IDs, a query speed may be lowered due to the additional filtering process and a safety problem may be caused due to exposure of unnecessary plaintext information.

Considering such a problem, in the present embodiment, a relative value changed using two key values is used together with a bucket ID, while a random number is produced as a first key value which is considered as a border for separating order informations within the bucket and a second key value functions to determine whether values within the bucket are arranged in a forward or a reverse order.

FIG. 2 is a flowchart illustrating a database processing method for keeping an order within a bucket partially in accordance with an embodiment of the present invention. FIGS. 3A and 3B are views of a particular example illustrating the database processing method for keeping an order within a bucket partially in FIG. 2.

For example, FIG. 3A illustrates an examination score ranging between 0 and 100. As shown in FIG. 3A, it is assumed that a bucket (c) is determined in accordance with bucket ranges within 0 to 100. If score 38 is provided, the bucket (c) corresponds to “f”. Since the start value s1 of the bucket (c) “f” is 36, a relative value (x) between 36 and 38 is 2. However, if the relative value (x) is maintained as it is, safety is weak. Thus, the relative value (x) is changed in accordance with the present invention, as shown in FIG. 2.

As shown in FIG. 2, if a plaintext (p) is inputted (S200), the bucket allocator 100 allocates the plaintext (p) to a specific bucket (c) (S202).

Thereafter, the database processor 102 calculates a relative value (x) of the plaintext (p) within the bucket depending on a bucket range (s1, s2) of the bucket (c) allocated by the bucket allocator 100 (S204). In this case, the relative value (x) may be expressed by the following Equation 1.

x=p−s1 (Equation 1)

After that, the database processor 102 produces a random number (N) within the bucket size (s2−s1) of the bucket (c) to generate a first key value (k1) (S206). That is, the first key value (k1) is a random number (N) within a range equal to or smaller than the bucket size (s2−s1). For example, since the bucket size (s2−s1) of the bucket (c) “f” (s1=36 and s2=41) is 5 (41-36), the first key value (k1) may be set as a random number (N) equal to or smaller than 5. In this case, the first key value (k1) functions to separate order informations within the bucket based on the random number (N) produced within the bucket range (s1, s2).

Subsequently, the database processor 102 applies a mod 2 operation to generate a second key value (k2) for defining a function (f) having the bucket range (s1, s2) as an input (S208). As shown in FIG. 3A, since the bucket (c) is “f” (s1=36 and s2=41) and the bucket size thereof (s2−s1) is 5 (41-36), the result value 1, obtained by applying the mod 2 operation with respect to 5, i.e., dividing 5 by 2, is generated as the second key value (k2).

Thereafter, the database processor 102 determines whether or not the second key value (k2) is 1 (S210) If the second key value (k2) is 1, the database processor 102 proceeds to step S212.

The database processor 102 arranges values within the bucket range (s1, s2) in a forward order at step S212, and then proceeds to step S216 in which a relative value for the plaintext (p), e.g., x=2, is changed to produce a changed relative value, e.g., y=4. The changed relative value (y) may be expressed by the following Equation 2.

y=x+(s−N), 0<x≦N

y=x−N, N<x≦s (Equation 2)

In the Equation 2, “y=x−N” is a function applied when a condition of “x>3” is satisfied. When the condition of “x>3” is not satisfied, function “y=x+(s−N)” is applied. Further, “s” of the Equation 2 represents the bucket size, i.e. “s=s2−s1”.

Meanwhile, in case where the second key value is 0, for example, in case where the bucket (c) is “e” (s1=71 and s2=79) in FIG. 3A and the bucket size thereof (s2−s1) is 8 (79−71), the result value 0, obtained by applying the mod 2 operation with respect to 8, i.e., dividing 8 by 2, is generated as the second key value (k2). If the second key value (k2) is 0, the database processor 102 proceeds to step S214.

The database processor 102 arranges values within the bucket range (s1, s2) in a reverse order at step S214, and then proceeds to step S216 in which a relative value for the plaintext (p), e.g., x=6, is changed to produce a changed relative value, e.g., y=7. The changed relative value (y) may be expressed by the following Equation 3.

y=s−x−(s−N), 0<x≦N

y=s−x+N, N<x≦s (Equation 3)

In the Equation 3, “y=s−x+N” is a function applied when a condition of “x>5” is satisfied. When the condition of “x>5” is not satisfied, function “y=s−x−(s−N)” is applied. Further, “s” of the Equation 3 represents the bucket size, i.e. “s=s2−s1”

If the process of changing the relative value (x) is completed, the database processor 102 stores the changed relative value (y) in the encryption database 104 (S218).

Subsequent processes (decryption and postprocessing processes) are not significantly related to core technology of the present invention, and are readily understood by those skilled in the art of the present invention. Thus, detailed description of the subsequent processes will be omitted.

FIG. 3B is a resultant graph illustrating a case where relative values (x) of plaintexts (p) within a bucket are changed.

In FIG. 3B, the left graph shows a case where relative values (x) are changed into changed relative values (y) by arranging values within a bucket range (s1, s2) in a forward order, and the right graph shows a case where relative values (x) are changed into changed relative values (y) by arranging values within a bucket range (s1, s2) in a reverse order.

Meanwhile, examples of a match and a range query will be described in detail with reference to FIGS. 2 and 3.

### <Match Query Comparison>

First, in case where an information of a student whose examination score is “38” is queried by using the match query, if the conventional art is applied, the following SQL sentence is transmitted to the encryption database 104, since the examination score 38 is within the bucket (c) “f” based on a mapping function.

select * from table_name where (bucket (c)=f);

That is, after fetching all informations of students whose buckets (c) are “f”, all encrypted values are decrypted, and a process of filtering only the information of the student belonging to examination score 38 should be performed.

However, in accordance with the present invention, the following SQL sentence is transmitted to the encryption database 104.

select * from table_name where (bucket (c)=f) and (y=4);

That is, all encrypted values corresponding to results of the above SQL sentence are decrypted.

### <Range Query Comparison>

It is assumed that a user requests a query of information on students belonging to examination scores ranging between 38 and 77.

In the conventional art, since bucket IDs corresponding to the range between 38 and 77 are “f”, “b”, “d”, “k” and “e”, the following SQL sentence is transmitted to the encryption database 104.

select * from table_name where (bucket (c)=f) and (bucket (c)=b) and (bucket (c)=d) and (bucket (c)=k) and (bucket (c)=e);

However, all values included in the bucket “f” or “e”, that are, respectively, the first or the last bucket included in the range query, are decrypted, and a filtering process of comparing to determine that the decrypted values are greater than 38 and smaller than 77 should be performed.

In accordance with the present invention, in the case of the other buckets except the first and the last bucket, the following SQL sentence is transmitted to the encryption database 104.

select * from table_name where (bucket (c)=b) and (bucket (c)=d) and (bucket (c)=k);

In the case of the first bucket, the following SQL sentence is transmitted to the encryption database 104.

select * from table_name where ((bucket (c)=f) and ((y>0) and (y<=2)) or ((y>4) and (y<=5)));

In the case of the last bucket, the following SQL sentence is transmitted to the encryption database 104.

select * from table_name where ((bucket (c)=e) and ((y>=0) and (y<5)) or ((y>=7) and (y<8)));

That is, all encrypted values corresponding to results of the three SQL sentences are decrypted.

As described above, the present invention keeps an order within a bucket partially with respect to real number data as well as integer data, so that not only safety but also query speed can be effectively secured even in a match, a range, a MIN, a MAX and a COUNT query.

In accordance with the present invention, safety and effectiveness of a query are simultaneously satisfied as compared with the conventional database encryption and query method, so that privacy policy can be implemented in state-run organizations, ISPs, web portals, monetary facilities, and the like.

While the invention has been shown and described with respect to the embodiments, it will be understood by those skilled in the art that various changes and modifications may be made without departing from the scope of the invention as defined in the following claims.

What is claimed is:

1. A database encryption and query method keeping an order within a bucket partially, which encrypts and stores numeric data in a database, comprising:
calculating a relative value of a plaintext within a bucket to which the plaintext is allocated;
generating a first key value by producing a random number within the bucket;
generating a second key value for defining a function having a bucket range of the bucket as an input; and
changing the relative value of the plaintext based on the first and the second key value with keeping an order of the relative value partially to store the changed relative value.

2. The method of claim 1, wherein the first key value is a value of separating order informations on the relative value of the plaintext with the random number produced within the bucket range as a border.

3. The method of claim 1, wherein the second key value is a resultant value obtained by applying a mod 2 operation to the bucket size of the bucket.

4. The method of claim 3, wherein, when the resultant value is 1, the relative value is changed by arranging values within the bucket range in a forward order.

5. The method of claim 3, wherein, when the resultant value is 0, the relative value is changed by arranging values within the bucket range in a reverse order.

6. The method of claim 1, further comprising decrypting for obtaining the relative value of the plaintext based on the first and the second key value with the changed relative value as an input value.
